(19) United States
(12) Patent Application Publication
(10) Pub. No.: US 2013/0216716 A1
(43) Pub. Date: Aug. 22, 2013

(54) NOZZLE FOR APPLYING A COATING AGENT

(71) Applicants: Stefan Ströhlein, Schwaigern (DE); Marc Engelhart, Sinsheim (DE)

(72) Inventors: Stefan Ströhlein, Schwaigern (DE); Marc Engelhart, Sinsheim (DE)

(21) Appl. No.: 13/817,354

(22) PCT Filed: Aug. 17, 2011
(86) PCT No.: PCT/EP11/04143

§ 371 Date: Mar. 12, 2013

(30) Foreign Application Priority Data
Aug. 20, 2010 (DE) 10-2010-034-921.6

(51) Int. Cl. B05B 15/08

(52) U.S. Cl. CPC B05B 15/08
USPC 427/421.1; 239/587.5

(57) ABSTRACT

The invention relates to a nozzle (1) for applying a coating agent, in particular for applying wax during seam sealing or for applying a preserving agent during cavity preservation on a vehicle body component, with an elongated hollow lance (4) for feeding the coating agent to be applied through the lance (4) along its longitudinal axis (17), as well as at least one nozzle opening (10, 11) for dispensing the coating agent, wherein the nozzle opening (10, 11) is arranged in the lateral surface of the lance (4) and dispenses the coating agent sidewards with respect to the longitudinal axis (17) of the lance (4). It is suggested that the nozzle opening (10, 11) is rotatable about the longitudinal axis (17) of the lance (4), so that the coating agent can be dispensed in different directions according to the angular position of the nozzle opening (10, 11).

In modern painting installations for painting motor vehicle body components, the motor vehicle body components to be painted are not only painted with the actual paint, but a seam sealing is also performed to help provide corrosion protection. Seam sealing may include application of a wax or other suitable coating agent to a seam (e.g. a flanged seam) along the seam by a robot-guided nozzle to prevent the seam from experiencing corrosion later. Known nozzles for applying a wax in the context of such seam sealing may include an elongated, hollow lance with a nozzle opening arranged in the lateral surface of the lance, through which the wax is applied. During the seam sealing, the lance may accordingly be positioned by a multi-axis robot so that the nozzle opening is always directed at the seam, which requires a high expenditure of processing for positioning the multi-axis robot. This positioning expenditure when guiding the known nozzles in turn leads to an extension of the required cycle time, and reduces the operating speed of the painting installation.

The same problems exist when preserving cavities with a preserving agent. Reference must also be made to EP 1 591 166 A1, U.S. Pat. No. 5,078,799 A, DE 10 2007 036 870 A1, DE 10 66 503 B and EP 0 941 788 A1, which describe additional general prior art.

As disclosed herein, a nozzle opening located in the lateral surface of a lance may be rotatable about the longitudinal axis of the lance, so that a coating agent (e.g. wax, preservation agent) can be dispensed in different directions according to an angular position of the nozzle opening. Therefore, in addition to a freedom of movement of a robot guiding the nozzle, the nozzle offers an additional degree of freedom so that positioning efforts of the robot are decreased because the nozzle itself can guide the nozzle opening into the desired direction.

The nozzle may include an elongated hollow lance that also serves for feeding a coating agent to be applied. In the lateral surface of the lance, there is at least one nozzle opening for discharging the coating agent, wherein the nozzle opening, with respect to the longitudinal axis of the lance, dispenses the coating agent in a sideways direction. In contrast to a conventional nozzle such as mentioned above, however, the nozzle opening can be rotated about a longitudinal axis of the lance so that a coating agent can be dispensed in a desired direction.

The lance may have a hollow inner nozzle pipe and a hollow outer nozzle pipe, wherein the inner nozzle pipe and the outer nozzle pipe are arranged coaxially and can be rotated relative to each other. The inner nozzle pipe may be arranged fixedly, whereas the outer nozzle pipe can be rotated.

The nozzle opening may be included in a wall of the rotatable outer nozzle pipe so that an angular position of the outer nozzle pipe determines a direction of application, i.e. a direction in which a coating agent is dispensed. For example, in the wall of the inner nozzle pipe, there may be at least one radially continuous borehole, which is aligned in a specific angular position of the outer nozzle pipe with the nozzle opening in the wall of the outer nozzle pipe so the coating agent can flow out of the nozzle opening. In this configuration, the coating agent is therefore fed via the hollow inner nozzle pipe, and then flows through the radially continuous borehole in the wall of the inner nozzle pipe, and finally through the nozzle opening in the wall of the outer nozzle pipe.

Further, there may be a sleeve-shaped gasket between the outer nozzle pipe and the inner nozzle pipe, The sleeve-shaped gasket surrounds the inner nozzle pipe in a circular manner, wherein the sleeve-shaped gasket may be fixed relative to the outer nozzle pipe, and there may be at least one radial borehole in its wall that is substantially flush with the borehole in the wall of the inner nozzle pipe. Furthermore, the sleeve-shaped gasket may respectively have an O-ring seal in the area of the radially continuous boreholes in order to seal the respective borehole.

Accordingly, the inner nozzle pipe and the outer nozzle pipe together may form a rotary slide valve with the rotating outer nozzle pipe as a control element, wherein the rotary slide valve releases or locks the nozzle opening depending on an angular position of the outer nozzle pipe.

The nozzle openings may be either released or locked by the rotary slide valve depending on the angular position of the outer nozzle pipe, essentially without interruption. It is, however, alternatively possible for the rotary slide valve to have an angle-dependent continuous valve characteristic, so that the nozzle openings are more or less released or locked depending on the angular position.

In addition, the rotary slide valve may release or lock different nozzle openings at different angular positions. For instance, two nozzle openings can be provided, wherein in a first angular position, the first nozzle opening is released and the second nozzle opening is locked, whereas in a second angular position, the first nozzle opening is locked and the second nozzle opening is released.

The different nozzle openings may be positioned in the outer nozzle pipe along the longitudinal axis of the lance in an axial extending line, i.e. without an angle offset in the circumferential direction. It is, however, alternatively possible in the framework of the invention for several nozzle openings to be distributed across the circumference.

In addition, the different nozzle openings may be spaced apart from one another axially. It is, however, alternatively possible for the nozzle openings to be spaced apart from one another in the circumferential direction, but have a substantially same position in the axial direction.

Furthermore, the nozzle may have a locking mechanism to lock the rotatable nozzle opening in a certain angular position. The locking mechanism may provide for several different locking positions to support dispensing the coating agent in different directions. For instance, the locking mechanism may have four different locking positions, each with an angle offset of substantially 90°.

For instance, the locking mechanism may have at least one resilient pressure piece and at least one locking receptacle, wherein the pressure piece can lock in a resilient manner in the locking receptacle to lock the nozzle in an angular position. If there are several locking positions, each locking position may be assigned a locking receptacle. In this constructive realization of the locking mechanism, the pressure piece on the one hand and the locking receptacle on the other hand are arranged in parts of the nozzle that can be rotated relative to each other. For instance, the locking receptacles may be arranged in the proximal end face of the outer nozzle pipe, whereas the resilient pressure piece is in a fixed support.

The nozzle may be rotated, for instance, manually using a wrench or another tool. To this end, the nozzle may have a wrench surface in which the wrench can engage. The wrench surface may be formed on a separate driver that is connected in a form-fitting manner to the outer nozzle pipe. The form-fitting connection between the driver on the one hand and the outer nozzle pipe on the other can be realized, for instance, in such a way that the outer nozzle pipe has an axial re-entering groove in its wall on the front side in which a corresponding axial projecting tongue on the driver engages.

It is, however, alternatively possible for the nozzle to have an integrated pivoting apparatus to rotate the nozzle opening to the desired angular position. For instance, such a pivoting apparatus can be operated electro-mechanically, pneumatically, hydraulically or by other means.

The nozzle opening may be rotatable without any limitation of the angle of rotation. This means that the nozzle opening can be rotated as far as desired in any direction without the nozzle opening needing to be rotated back again. This is advantageous because the positioning expenditure is thereby reduced, which contributes to accordingly shorter cycle times.

The nozzle according described above as an individual component may be included in a complete application device with such a nozzle. In the context of such an application device, the nozzle can for instance by guided by a multi-axis robot.

In addition, it should be noted that the term “coating agent” used herein is not limited to waxes or other preserving agents that are used during seam sealing or during preserving cavities. Rather, this term also comprises other coating agents such as acoustic foam for sound insulation, corrosion protection agents, coating agents for disc flange masking, preserving agents for preserving cavities, and coating agents for underbody protection, just to name a few examples.

As also disclosed herein, a nozzle may be used for applying wax or another preserving agent during seam sealing or cavity preservation on a vehicle body component.

The figures show as follows:

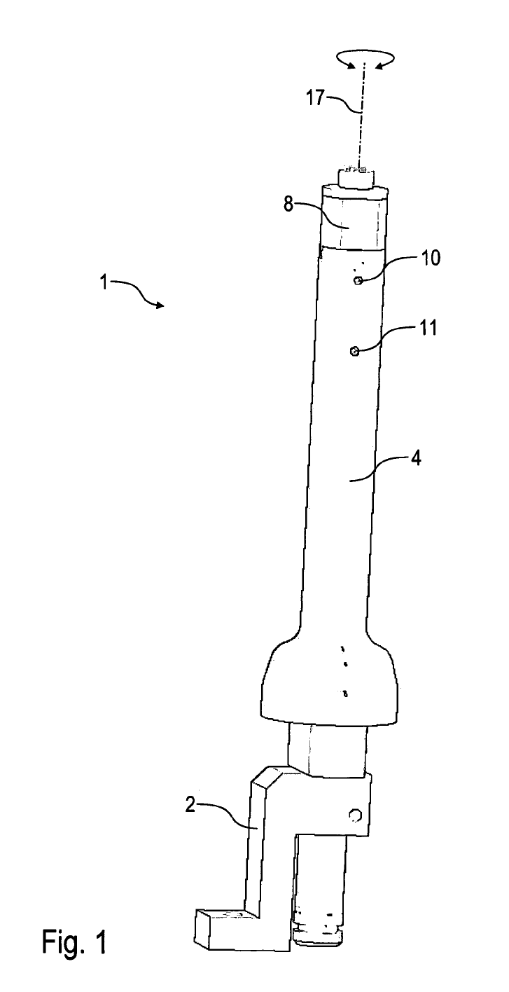

FIG. 1: a perspective side view of an exemplary nozzle for applying wax during seam sealing or cavity preservation on a motor vehicle body component,

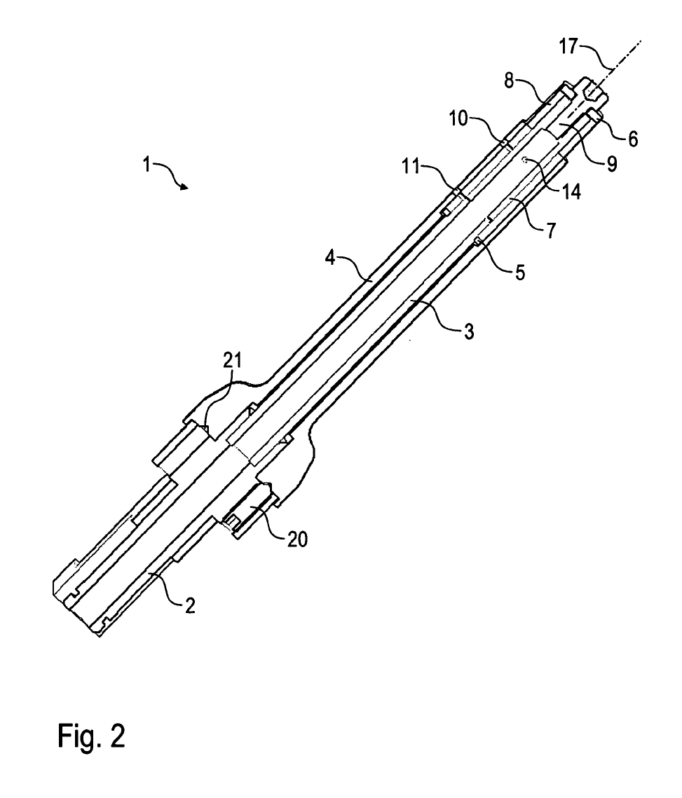

FIG. 2: a longitudinal section through the nozzle of FIG. 1,

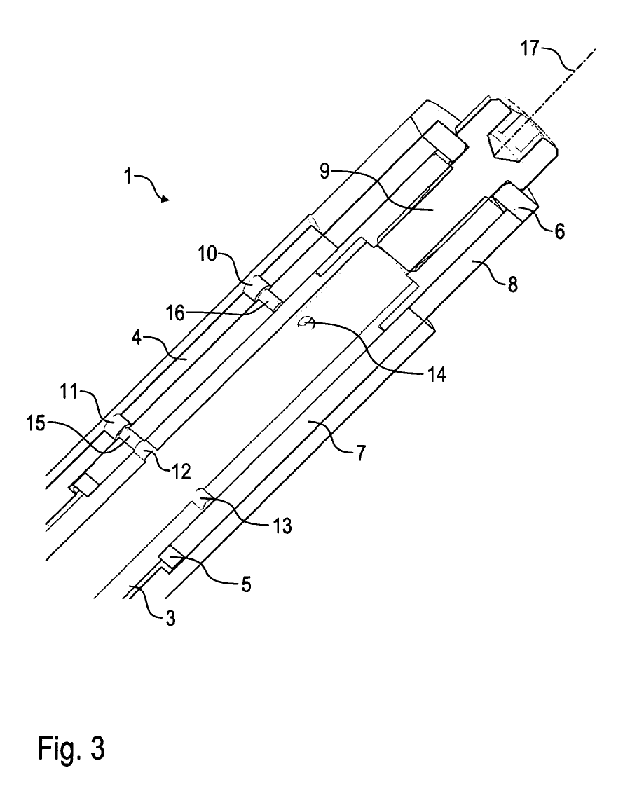

FIG. 3: a detailed view of the longitudinal section from FIG. 2 in the front region of the nozzle,

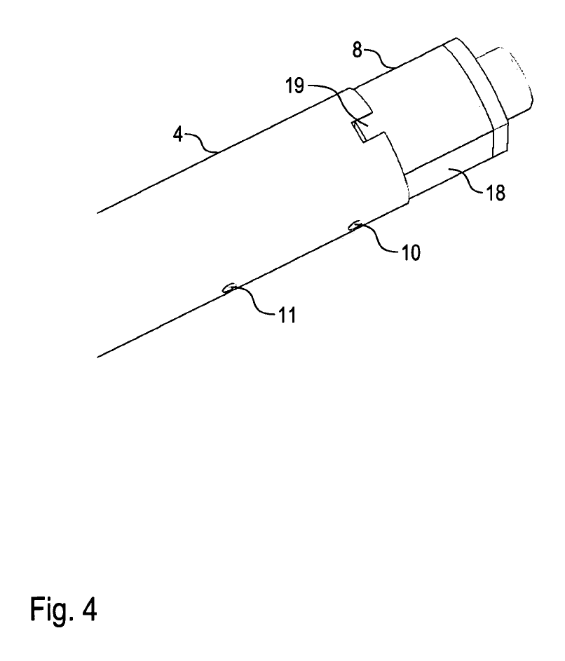

FIG. 4: a perspective side view of the front region of the nozzle of FIG. 1,

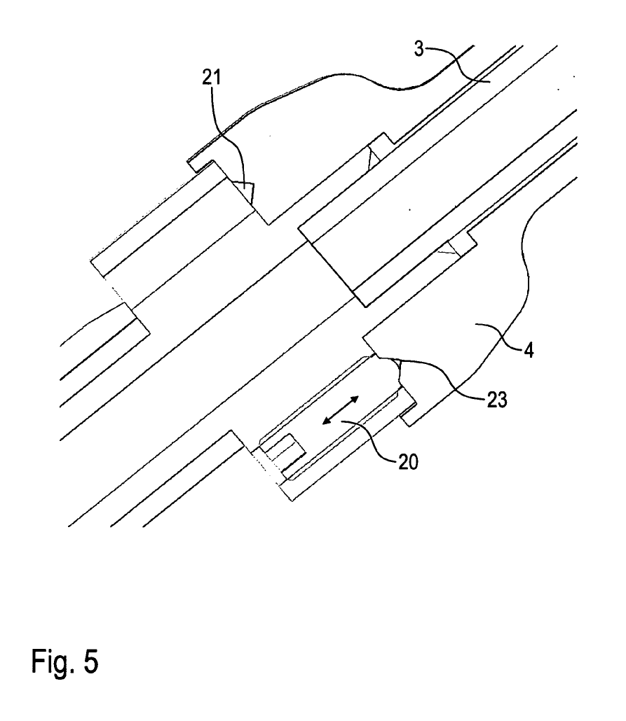

FIG. 5: a magnification of the longitudinal section from FIG. 2 in the rear region of the nozzle,

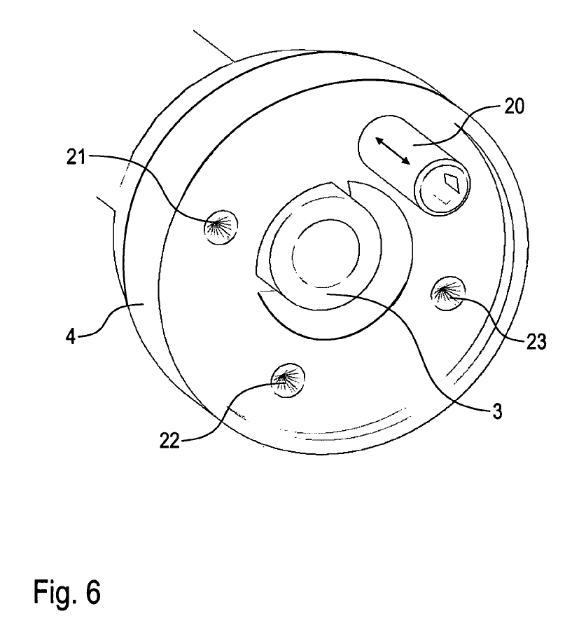

FIG. 6: a perspective view of the locking mechanism of the nozzle of FIG. 1,

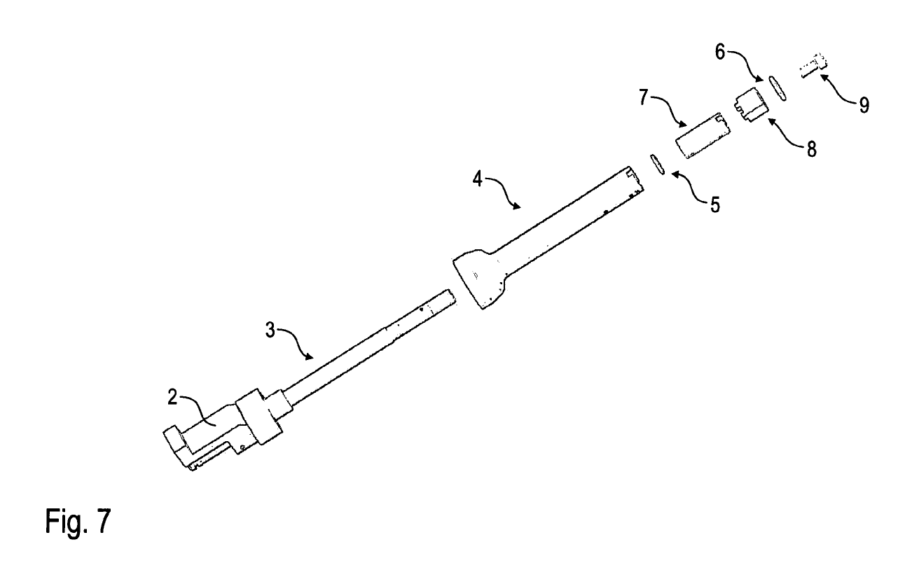

FIG. 7: a perspective exploded view of the nozzle from FIG. 1,

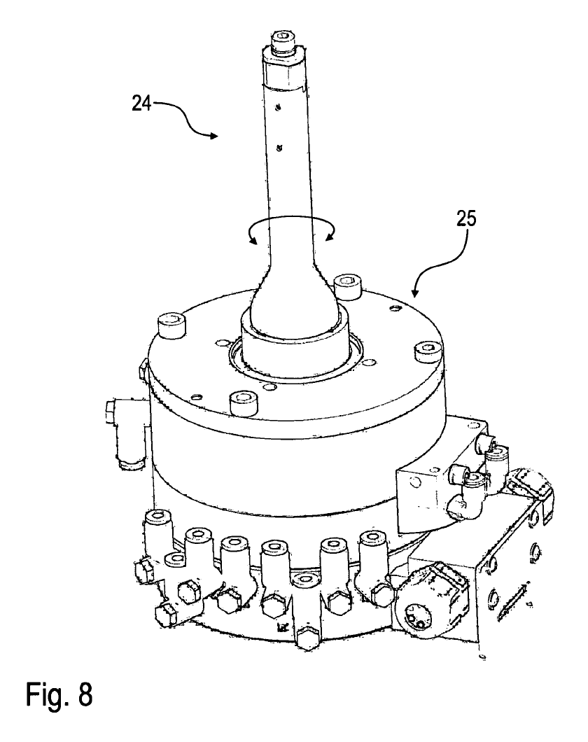

FIG. 8: an exemplary application device with a nozzle.

FIGS. 1 to 7 illustrate different views of a first exemplary nozzle 1 that can be used in the framework of seam sealing or cavity preservation on a motor vehicle body component for applying wax or another preserving agent.

Using a support 2, the nozzle 1 can be guided by a conventional multi-axis robot to apply wax along a seam or within a cavity.

Here, the nozzle 1 consists essentially of a hollow inner nozzle pipe 3, and also hollow outer nozzle pipe 4, two washers 5, 6, a sleeve-shaped gasket 7, a driver 8 and a mounting screw 9, which is particularly apparent in the exploded view in FIG. 7.

The inner nozzle pipe 3 is arranged fixed in the nozzle 1, whereas the outer nozzle pipe 4 can be rotated relative to the inner nozzle pipe, wherein the inner nozzle pipe 3 and the outer nozzle pipe 4 are arranged coaxially.

In a wall of the outer nozzle pipe 4, there are two nozzle openings 10, 11, wherein the two nozzle openings 10, 11 are arranged along an axial line, i.e. without an angle offset in the circumferential direction, but spaced apart axially from each other.

In a wall of the inner nozzle pipe 3, there are also radially continuous boreholes 12, 13, 14 to allow wax to get from the inside of the inner nozzle pipe 3 to the nozzle openings 10, 11 in the outer nozzle pipe 4.

Furthermore, the sleeve-shaped gasket 7 is located between the outer nozzle pipe 4 and the inner nozzle pipe 3, wherein two radially continuous boreholes are arranged in the wall of the gasket 7.

In the angular position of the outer nozzle pipe 4 illustrated in FIG. 3, the nozzle opening 11 in the outer nozzle pipe 4 is aligned with the borehole 15 of the gasket 7 and the borehole 12 in the inner nozzle pipe 3 so that the wax can flow from the inside of the inner nozzle pipe 3, through the boreholes 12, 15 and out of the nozzle opening 11. In contrast, in this angular position of the outer nozzle pipe 4, the other nozzle opening 10 is blocked by the wall of the inner nozzle pipe 3 so that no wax can flow out of the nozzle opening 10.

If, in contrast, the outer nozzle pipe 3 is rotated about an axis of rotation by 90° relative to the inner nozzle pipe 3, the nozzle opening 10 aligns with borehole 16 and borehole 14 so that the wax can flow out through the nozzle opening 10 whereas the other nozzle opening 11 is blocked.

The outer nozzle pipe 4 can be rotated to the desired angular position by the driver 8 which, for this purpose, has a wrench surface 18 in which a correspondingly suitable wrench can engage. Furthermore, the driver 8 is connected in a form-fitting manner to the outer nozzle pipe 4. To this end, the outer nozzle pipe 4 has an axial re-entering groove on the front face into which engages a corresponding axially projecting tongue 19 of the driver 8.

Furthermore, the nozzle 1 according to the invention has a locking mechanism which is illustrated in FIGS. 5 and 6 and allows for the outer nozzle pipe 4 to be locked in one of four possible angular positions. To this end, the locking mechanism has an axially resilient slidable pressure piece 20, wherein the pressure piece 20 can engage into one of four locking receptacles 21-23 to lock the outer nozzle pipe 4 in a respective angular position. The locking receptacles 21-23 and the unidentifiable fourth locking receptacle are here mounted on the proximal front face of the outer nozzle pipe 4.

FIG. 8 illustrates an additional exemplary nozzle 24, which is generally designed in the manner described above and functions so that in this context, reference is made to the description above.

In this exemplary embodiment, however, using a bayonet fastener, the nozzle 24 is mounted in an application device 25 which, on the one hand, allows for the nozzle 24 to be actively rotated and on the other hand, also provides the coating agent (e.g. wax).

The invention is not limited to the exemplary embodiments described above. Instead, a plurality of variants and modifications are possible, which also make use of the concept of the invention and thus fall within the scope of protection. Furthermore, the invention also claims protection for the subject-matter and the features of the subclaims independently of the features of the claims to which they refer.

1-13. (canceled)

14. A nozzle, comprising:
an elongated hollow lance configured for feeding a coating agent through the lance along a longitudinal axis of the lance; and
at least one nozzle opening configured for dispensing the coating agent;
wherein the nozzle opening is arranged in a lateral surface of the lance and dispenses the coating agent sideways with respect to the longitudinal axis of the lance; and
further wherein the nozzle opening is rotatable about the longitudinal axis of the lance such that the coating agent can be dispensed in different directions according to an angular position of the nozzle opening.

15. The nozzle according to claim 14, wherein:
the lance includes a hollow inner nozzle pipe and a hollow outer nozzle pipe,
the inner nozzle pipe and the outer nozzle pipe are arranged coaxially, and
the outer nozzle pipe with the nozzle opening located therein is rotatable relative to the inner nozzle pipe to adjust the angular position of the nozzle opening.

16. The nozzle according to claim 15, wherein the inner nozzle pipe is stationary and the outer nozzle pipe is rotatable.

17. The nozzle according to claim 15, wherein:
the coating agent flows through the hollow inner nozzle pipe to the nozzle opening, and
the inner nozzle pipe includes a wall that has at least one radially continuous borehole, the borehole being aligned at a predetermined angular position with the nozzle opening in a wall of the outer nozzle pipe, whereby the coating agent can flow out of the nozzle opening.

18. The nozzle according to claim 17, wherein the inner nozzle pipe and the outer nozzle pipe form a rotary slide valve having the outer nozzle pipe as a control element, wherein the rotary slide valve frees or locks the nozzle openings depending on the angular position of the outer nozzle pipe.

19. The nozzle according to claim 18, wherein the rotary slide valve frees or locks the nozzle openings in an essentially transition-free manner depending on the angular position of the outer nozzle pipe.

20. The nozzle according to claim 18, wherein the inner nozzle pipe has in its wall a plurality of radially continuous boreholes that are arranged in different angular positions.

21. The nozzle according to claim 20, wherein a plurality of nozzle openings are arranged in the wall of the outer nozzle pipe, wherein each of the nozzle openings is assigned to one of the boreholes in the wall of the inner nozzle pipe.

22. The nozzle according to claim 15, wherein:
a sleeve-shaped gasket is arranged between the outer nozzle pipe and the inner nozzle pipe, the sleeve-shaped gasket surrounding the inner nozzle pipe in an annular manner, and
the sleeve-shaped gasket is fixed relative to the outer nozzle pipe and has in its wall at least one radial borehole that is aligned with the nozzle opening in the wall of the outer nozzle pipe.

23. The nozzle according to claim 22, wherein the sleeve-shaped gasket has an O-ring seal proximate to each of the boreholes.

24. The nozzle according to claim 14, wherein
along the longitudinal axis of the lance, a plurality of nozzle openings are arranged axially spaced apart from one another, and
the different nozzle openings are arranged along an axial-running line, such that the different nozzle openings dispense the coating agent in a same direction.

25. The nozzle according claim 14, further comprising a locking mechanism configured to lock the nozzle opening in a defined angular position.

26. The nozzle according to claim 25, wherein
the locking mechanism includes at least one resilient pressure piece and at least one locking receptacle, wherein the pressure piece can lock in a resilient manner in the locking receptacle to lock the nozzle in a defined angular position, and
the pressure piece and the locking receptacle are arranged in respective parts of the nozzle that are rotatable relative to one another.

27. The nozzle according to claim 26, wherein the locking mechanism includes a plurality of locking receptacles to allow for a plurality of rotational positions of the nozzle.

28. The nozzle according to claims 14, wherein
the nozzle includes a wrench surface to allow for rotation of the nozzle opening by a wrench to a desired rotational position,
the wrench surface is formed on a driver that is connected in a form-fitting manner with the outer nozzle pipe, and
the outer nozzle pipe on a front face of a wall, an axially re-entering groove, in which an accordingly axially projecting tongue on the driver is configured to engage to connect the driver in a form-fitting manner with the outer nozzle pipe.

29. The nozzle according to claim 14, wherein the nozzle opening is rotatable without any limitation of an angle of rotation.

30. The nozzle according to claim 14, wherein the nozzle is adapted for applying wax during seam sealing or for applying a preservation agent during cavity preservation on a vehicle body component.

31. An application device comprising a nozzle, the nozzle including:
an elongated hollow lance configured for feeding a coating agent through the lance along a longitudinal axis of the lance; and
at least one nozzle opening configured for dispensing the coating agent;
wherein the nozzle opening is arranged in a lateral surface of the lance and dispenses the coating agent sideways with respect to the longitudinal axis of the lance; and
further wherein the nozzle opening is rotatable about the longitudinal axis of the lance such that the coating agent can be dispensed in different directions according to an angular position of the nozzle opening.

32. The application device according to claim 31, further comprising a pivoting apparatus for rotating the nozzle opening into a desired angular position.

33. The application device according to claim 31, further comprising a bayonet fastener configured to releasably fix the nozzle in the application device.

34. A method, comprising using a nozzle to apply at least one of (i) wax during seam sealing and (ii) a preservation agent during cavity preservation on a vehicle body component, wherein the nozzle comprises:
an elongated hollow lance configured for feeding a coating agent through the lance along a longitudinal axis of the lance; and
at least one nozzle opening configured for dispensing the coating agent;
wherein the nozzle opening is arranged in a lateral surface of the lance and dispenses the coating agent sideways with respect to the longitudinal axis of the lance; and
further wherein the nozzle opening is rotatable about the longitudinal axis of the lance such that the coating agent can be dispensed in different directions according to an angular position of the nozzle opening.
